(19) United States
(12) Patent Application Publication
(10) Pub. No.: US 2026/0299595 A1
(43) Pub. Date: Oct. 1, 2026

(54) SYSTEMS AND METHODS FOR AUTOMATIC ESTIMATION OF THE DETECTION SYSTEMS OBSCURED AREAS FOR SAFE AUTONOMOUS VEHICLE NAVIGATION

(71) Applicant: AVRIDE Inc., Newburyport, MA (US)

(72) Inventors: Mikhail Erofeev, Austin, TX (US); Mikhail Sarkisian, Tel Aviv (IL); Lev Simonov, Tel Aviv (IL); Andrey Rykov, Austin, TX (US)

(21) Appl. No.: 19/578,652

(22) Filed: Mar. 25, 2026

Related U.S. Application Data
(60) Provisional application No. 63/777,206, filed on Mar. 25, 2025.

(51) Int. Cl. G05D 1/617; G05D 1/242; G05D 1/243; G05D 1/246; G05D 101/15; G05D 111/10

(52) U.S. Cl. CPC G05D 1/617; G05D 1/242; G05D 1/2435; G05D 1/2464; G05D 2101/15; G05D 2111/17

(57) ABSTRACT

Provided herein is a system and method for automatic estimation of detection system obscured areas for autonomous vehicle navigation, the system including: at least one processor; and a memory, wherein the memory contains instructions configuring the at least one processor to: receive an object model from an object database; receive from an autonomous vehicle, a plurality of real-world LIDAR data and real-world camera data; insert a plurality of copies of the object model into the 3D space to form augmented data; and determine, using a perception system, a detection status for each of the plurality of copies of the object model in the 3D space.

### CROSS REFERENCE TO RELATED APPLICATIONS

This application claims the benefit of priority to U.S. Provisional App. No. 63/777,206, filed on Mar. 25, 2025, and entitled “SYSTEMS AND METHODS FOR AUTOMATIC ESTIMATION OF THE DETECTION SYSTEMS OBSCURED AREAS FOR SAFE AUTONOMOUS VEHICLE NAVIGATION,” the entirety of which is incorporated herein by reference.

### FIELD OF THE INVENTION

The present invention is directed to methods of improving autonomous vehicle navigation systems; particularly, systems and methods for automatic estimation of the detection systems obscured areas for safe autonomous vehicle navigation.

### BACKGROUND OF THE INVENTION

Historically, conventional autonomous vehicle navigation systems provide a way of estimating obscured areas and providing data in regard to these detections. However, these navigation systems employed fail to provide an accurate estimation of “blind spots” and other vital obscured areas. This evidences a disadvantage in that these navigation systems are not fully reliable creating a safety concern. Therefore, the need exists for a system and method for automatically estimating obscured areas that enhances the reliability and safety of autonomous vehicle navigation while addressing the critical safety concern of “blind spots” caused by physical occlusions or sensor limitations.

Accordingly, there remains a need in the art for systems and methods that improve upon existing processes for obscured area detection. The present disclosure meets this need.

### SUMMARY

In some aspects, the techniques described herein relate to a system for automatic estimation of detection system obscured areas for autonomous vehicle navigation, the system including: at least one processor; and a memory, wherein the memory contains instructions configuring the at least one processor to: receive an object model from an object database, wherein the object model includes a LIDAR mask and an RGB mask; receive from an autonomous vehicle, a plurality of real-world LIDAR data and real-world camera data, wherein the real-world LIDAR data and real-world camera data describe a three-dimensional (3D) space at least partially surrounding the autonomous vehicle; and insert a plurality of copies of the object model into the 3D space to form augmented data, wherein inserting the plurality of copies of the object model into the 3D space includes: performing an RGB ray-casting procedure including updating RGB image pixels with pixels from the inserted object model; and performing a LIDAR ray-casting procedure, including: determining a plurality of projected LIDAR points; determining depth values for each of the projected LIDAR points as a function of the LIDAR mask; and geometrically modeling, as a function of the depth values and the projected LIDAR points, return locations for LIDAR rays that hit the projected LIDAR points; and determine, using a perception system, a detection status for each of the plurality of copies of the object model in the 3D space.

In some aspects, the techniques described herein relate to a method for automatic estimation of detection system obscured areas for autonomous vehicle navigation, the method including: receiving, using at least a processor, an object model from an object database, wherein the object model includes a LIDAR mask and an RGB mask; receiving, using the at least a processor and from an autonomous vehicle, a plurality of real-world LIDAR data and real-world camera data, wherein the real-world LIDAR data and real-world camera data describe a three-dimensional (3D) space at least partially surrounding the autonomous vehicle; and inserting, using the at least a processor, a plurality of copies of the object model into the 3D space to form augmented data, wherein inserting the plurality of copies of the object model into the 3D space includes: performing an RGB ray-casting procedure including updating RGB image pixels with pixels from the inserted object model; and performing a LIDAR ray-casting procedure, including: determining a plurality of projected LIDAR points; determining depth values for each of the projected LIDAR points as a function of the LIDAR mask; and geometrically modeling, as a function of the depth values and the projected LIDAR points, return locations for LIDAR rays that hit the projected LIDAR points; and determining, using the at least a processor and a perception system, a detection status for each of the plurality of copies of the object model in the 3D space.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1A shows an exemplary embodiment of a system for automatic estimation of detection system obscured areas for autonomous vehicle navigation;

FIG. 1B shows another exemplary embodiment of a system for automatic estimation of detection system obscured areas for autonomous vehicle navigation;

FIG. 2 shows an exemplary object model;

FIG. 3 shows an exemplary data mask;

FIG. 4 shows an exemplary embodiment of a plurality of projected LIDAR points on an object model;

FIG. 5 shows an exemplary embodiment of a visibility grid;

FIGS. 6A and 6B show an exemplary vehicle computing architecture;

FIG. 7 shows an exemplary LIDAR system;

FIG. 8 shows an exemplary machine-learning module;

FIG. 9 shows an exemplary neural network;

FIG. 10 shows a method for automatic estimation of detection system obscured areas for autonomous vehicle navigation; and

FIG. 11 shows a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

For the purposes of this disclosure, an “object model,” is a model of an object, person, or being.

A “LIDAR mask,” for the purposes of this disclosure, is a data layer that separates LIDAR points between the target object and the remaining scene..

An “RGB mask,” for the purposes of this disclosure, is a data layer separates RGB data between the target object and the remaining scene..

A “collection distance,” for the purposes of this disclosure, is a distance between a datapoint or model and a sensor that collected it.

For the purposes of this disclosure, an “autonomous vehicle” is a device that is capable of moving people or things from one point to another in a manner that relies primarily on computer algorithms to guide and control the vehicle.

An “insertion position,” for the purposes of this disclosure is a location at which a model is desired to be inserted into a 3D space.

### DETAILED DESCRIPTION

The present invention is directed generally to a method and apparatus for autonomous vehicle navigation and, more particularly, to a system and method for automatic estimation of the detection system's obscured areas for safe autonomous vehicle navigation.

The present invention also includes a method of combining offboard synthetic data generation with onboard machine learning for real-time obscured area estimation. Offboard synthetic data generation may be data or resource intensive and therefore not suitable for being done on board. The onboard machine-learning may be lighter weight, and, thus, able to be run an onboard computing system. Therefore, the present invention provides a powerful obscured area detection algorithm, wherein the most processing intensive tasks can be performed offboard.

The present invention solves problems experienced with the prior art because it provides a system and method for automatically estimating obscured areas that enhances the reliability and safety of autonomous vehicle navigation. Those and other advantages and benefits of the present invention will become apparent from the detailed description of the invention hereinbelow. The system may be fully automated, eliminating the need for manual labeling, and providing a crucial safety feature for autonomous vehicle navigation.

### System for Automatic Estimation of Detection System Obscured Areas for Autonomous Vehicle Navigation

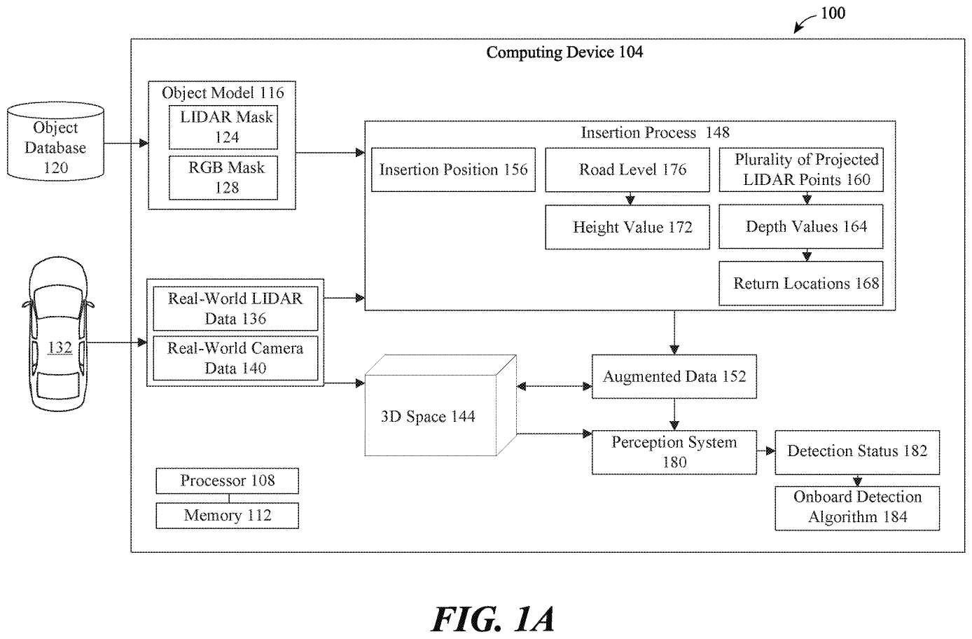

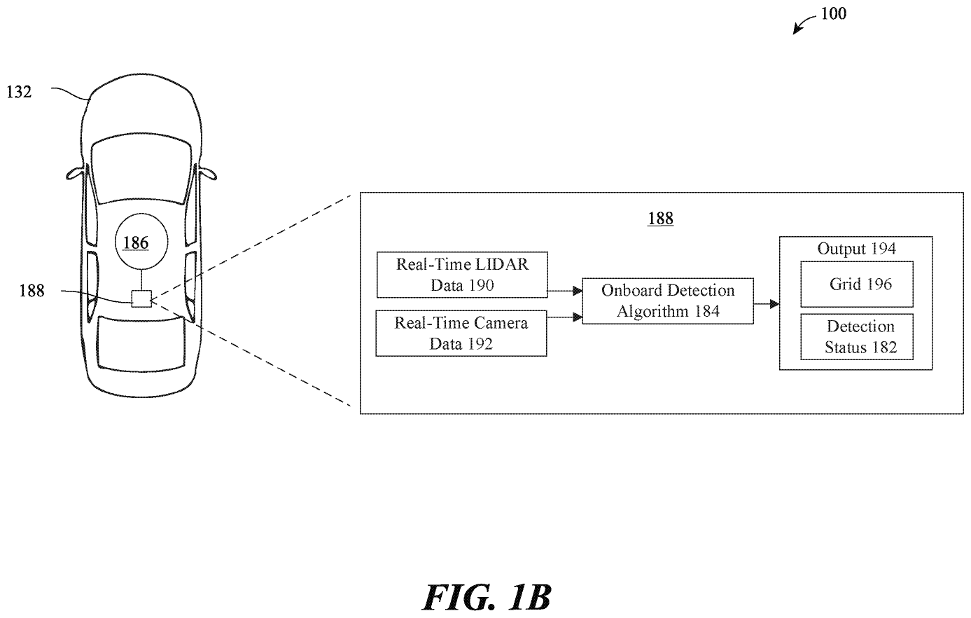

Referring now to FIG. 1A, an exemplary embodiment of system 100 for automatic estimation of detection system obscured areas for autonomous vehicle navigation is illustrated. System 100 may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1A, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1A, computing device 104 may include at least one processor 108. The at least one processor 108 may be communicatively connected to a memory 112. Memory 112 may contain instructions configuring the at least one processor 108 to perform one or more actions as described throughout this disclosure.

With continued reference to FIG. 1A, memory 112 may include instructions configuring processor 108 to receive an object model 116 from an object database 120. Object model database 120 may be implemented, without limitation, as a relational database, a key-value retrieval database such as a NOSQL database, or any other format or structure for use as a database that a person skilled in the art would recognize as suitable upon review of the entirety of this disclosure. Object model database 120 may alternatively or additionally be implemented using a distributed data storage protocol and/or data structure, such as a distributed hash table or the like. Object model database 120 may include a plurality of data entries and/or records as described above. Data entries in a database may be flagged with or linked to one or more additional elements of information, which may be reflected in data entry cells and/or in linked tables such as tables related by one or more indices in a relational database. People skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1A, object model 116 may include a LIDAR mask 124. In some embodiments, LIDAR mask 124 may filter out data that is not part of object model 116. For example, LIDAR mask 124 may include a plurality of LIDAR datapoints of object model 116.

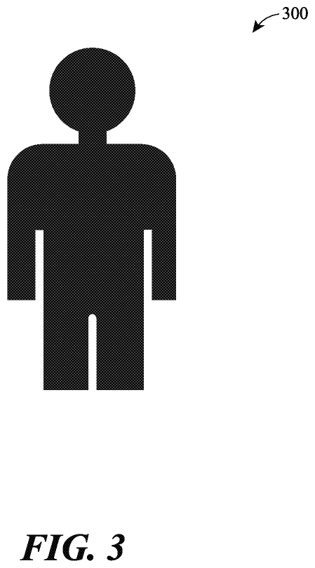

With continued reference to FIG. 1A, object model 116 may include an RGB mask 128. RGB mask 128 may include, as a non-limiting example, color data for the object of object model 116. RGB mask 128 may include, as a non-limiting example, camera data for the object of object model 116. In some embodiments, RGB mask 128 may define the object's silhouette which includes corresponding RGB image pixels. An exemplary data mask is described further with respect to FIG. 3.

With continued reference to FIG. 1A, LIDAR mask 124 and/or RGB mask 128 may include a bounding box. Bounding box may include a box that surrounds the object in relation to its environment. As non-limiting examples, object model 116 may include LIDAR point clouds, bounding boxes, camera data, RGB data, and the like.

With continued reference to FIG. 1A, in some embodiments, object model 116 may include a model of a commonly-encountered object. A commonly-encountered object is an object that an autonomous vehicle is likely to encounter or has commonly encountered during its normal use. As non-limiting examples, commonly-encountered objects may include cars, stop signs, pedestrians, bikes, bikers, motorbikes, motorbikers, buildings, fire hydrants, signs, exit signs, road signs, and the like. In some embodiments, object model 116 may include rare objects. Rare objects may be objects that it is rare for an autonomous vehicle to encounter in the context of the vehicle's environment. Rare entities may include, as non-limiting examples, kids, wheelchairs, dogs, rodents, strollers, and the like.

With continued reference to FIG. 1A, object model 116 may be extracted from or created using real-world sensor data. As non-limiting examples, real-world sensor data may include LIDAR point clouds and/or RGB images. Real-world sensor data may be used to create representative 3D object models of typical objects of interest.

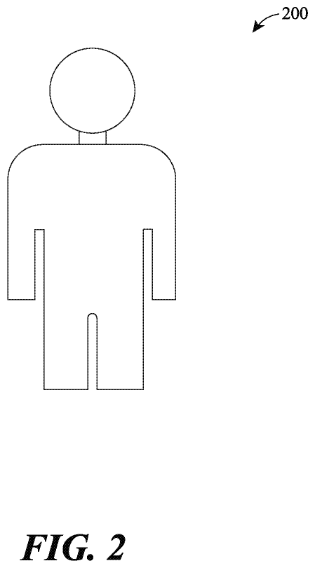

Referring now to FIG. 2, an exemplary object model 200 is shown. Those skilled in the art, after having reviewed the entirety of this disclosure, would appreciate that while exemplary object model 200 is depicted in FIG. 2 as a two-dimensional (2D) object, that object model may represent a three-dimensional (3D) object. In some embodiments, exemplary object model 200 may be a common object. For example, in some embodiments, exemplary object model 200 may include a model of a pedestrian or car.

Referring now to FIG. 3, an exemplary data mask 300 is shown. Data mask 300 may include an RGB data mask. Data mask 300 may define an object's silhouette which may include corresponding RGB image pixels.

Referring back to FIG. 1A, memory 112 may include instructions configuring processor 108 to select a random object model 116 from object model database 120. For example, object model database 120 may include a plurality of object models 116. Processor 108 may be configured to randomly select one or more of the plurality of object models 116. This may serve to prevent bias in the selection of object model 116.

With continued reference to FIG. 1A, object model 116 may be constructed primarily of data from an original autonomous vehicle. Autonomous vehicles, such as those equipped with LIDAR and/or camera sensors may gather data regarding the environments that they encounter. This may happen passively; i.e., autonomous vehicles may store data that they collect from environments as they go about their tasks. In some cases, these autonomous vehicles will encounter objects. As non-limiting examples, an oncoming car, a stop sign, a pedestrian, or the like. As part of its data collection, the autonomous vehicle may collect data on this object.

With continued reference to FIG. 1A, objects may be manually identified within the data from the original autonomous vehicles. For example, a user may identify a sign, oncoming car, or pedestrian. These identified objects may be saved to object model database 120 as object models 116.

With continued reference to FIG. 1A, objects may be captured when they are close to the vehicle. This may allow for more detailed object models. This is the case at least because LIDAR beams spread out as they move further from the LIDAR sensor, decreasing the density of data gathered. Additionally, camera resolution limits the detail of an image, thereby limiting the data captured for far away objects. As such, using objects that are close to the vehicle for object model 116 may be beneficial.

With continued reference to FIG. 1A, memory 112 may include instructions configuring processor 108 to filter a plurality of object models 116 in the object model database 120 as a function of a threshold collection distance. Memory 112 may include instructions configuring processor 108 to select object model 116 from the plurality of object models where the collection distance is below the threshold collection distance. For example, if a pedestrian was 3 m from a LIDAR sensor when it was scanned, the collection distance may be below a threshold of 4 m. In some embodiments, collection distance may include an average distance of an object from the sensor. This procedure may allow for processor 108 to select only object models 116 that were collected when they were close to the autonomous vehicle. This may allow for selection of object models 116 with a higher density of data. This may allow for better insertion into the 3D space 144. In some embodiments, object model database may include an orientation for object model 116 wherein. System 100 may select object models 116 from object model database as a function of the orientation of the object model, wherein the object model 116 may be selected as a function of the orientation such that the orientation matches the direction of the lane (or sidewalk) into which the object is being inserted.

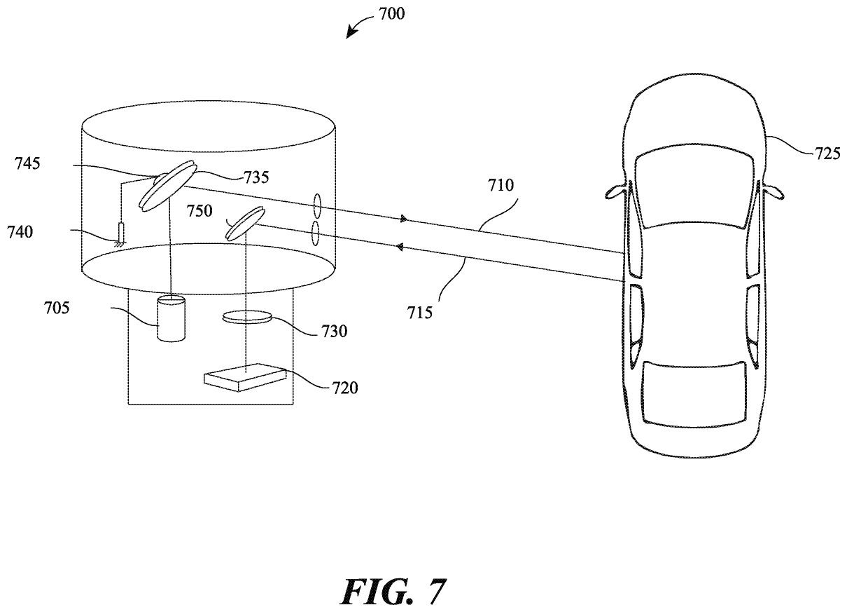

With continued reference to FIG. 1A, memory 112 may include instructions configuring processor 108 to receive, from an autonomous vehicle 132, a plurality of real-world LIDAR data 136 and real-world camera data 140. Real-world data may include data that has been collected from one or more scenarios in the real-world. For example, data collected by an autonomous vehicle 132 while it drives around a city would constitute real-world data. Real-world LIDAR data 136 is real-world data collected using a LIDAR sensor. LIDAR sensor is described further with reference to FIG. 7. Real-world camera data 140 is real-world data collected using a camera. For example, real-world camera data 140 may include images or videos collected using a camera.

With continued reference to FIG. 1A, in some embodiments, real-world LIDAR data 136 and real-world camera data 140 may describe a three-dimensional (3D) space 144 at least partially surrounding autonomous vehicle 132. For example, 3D space 144 may include the road, pedestrians, traffic lights, signs, cityscape, crosswalks, other vehicles, or other objects that a vehicle commonly encounters. In some embodiments, 3D space 144 may include a 360 degree view of the surroundings of the vehicle. In embodiments, the distance from the vehicle determined by real world LIDAR data 136 may allow for the construction of the 3D space 144.

With continued reference to FIG. 1A, memory 112 may include instructions configuring processor 108 to perform an insertion process 148. Insertion process 148 may be configured to insert a plurality of object models 116 into 3D space 144 to form augmented data 152.

With continued reference to FIG. 1A, insertion process 148 may include identifying an insertion position 156. In some embodiments, object models 116 may be synthetically inserted into real-world scene data (E.g., plurality of real-world LIDAR data 136 and real-world camera data 140) at various locations. In some embodiments, insertion process 148 may include identifying a plurality of insertion positions 156 for a plurality of object models 116. In some embodiments, object models 116 may be inserted at insertion positions 156 all around the scene. In some embodiments, insertion of object models 116 may include excluding the mutual occlusion of object models 116 by each other.

With continued reference to FIG. 1A, in some embodiments, the space surrounding autonomous vehicle 132 may be discretized into a grid. As a non-limiting example, grid may include grid lines every 6 inches. As a non-limiting example, grid may include grid lines every 1 foot. As a non-limiting example, grid may include grid lines every 2 feet. As a non-limiting example, grid may include grid lines every 4 feet. As a non-limiting example, grid may include grid lines every 6 feet. As a non-limiting example, grid may include grid lines every 10 feet. In some embodiments, grid may include grid lines every 1 inch to 10 feet. In some embodiments, grid may include grid lines every 3 feet to 8 feet. In some embodiments, insertion position 156 may be the center of a cell of the grid. In some embodiments, grid may include a plurality of non-overlapping spatial cells (e.g., squares). In some embodiments, plurality of insertion positions 156 may be determined as the center of every cell in grid. In some embodiments, plurality of insertion positions 156 may be chosen to fill or substantially saturate 3D space 144 with object models 116.

With continued reference to FIG. 1A, determining insertion position 156 of object model 116 may include determining an overlap metric as a function of insertion position 156 and object model 116. In some embodiments, overlap metric may be a measure of whether the object model 116 overlaps with existing objects at insertion position 156. This may be determined by using LIDAR mask 124 for object model 116 and plurality of real-world LIDAR data 136 for 3D space 144. As a non-limiting example, processor 108 may compare the LIDAR datapoints associated with object model 116 with plurality of real-world LIDAR data 136 to determine if one conflicts with the other. For example, at a distance of 10 meters and a chosen angle, plurality of real-world LIDAR data 136 may indicate that there is no object for 20 meters at one side of object model 116 but that there is only no object for 8 meters at a second side of object model 116. Thus, overlap may be detected. overlap metric may be, as non-limiting examples, a percent overlap or a value on a scale. The determination of an overlap metric may determine the feasibility of the insertion by ensuring that the inserted object does not overlap with existing objects in the scene and does not cast excessive shadows on existing objects in 3D space.

With continued reference to FIG. 1A, if an overlap metric exceeds a feasibility threshold, then processor 108 may be configured to automatically determine a new insertion position 156. In some embodiments, this may be performed iteratively until a feasible selection (i.e. where overlap metric falls below a feasibility threshold) is found.

With continued reference to FIG. 1A, in some embodiments, processor 108 may be configured to iteratively repeat insertion process 148 until a desired number of object models 116 are inserted. In some embodiments, this may include conducting the steps of insertion process 148 in series. Or, alternatively, some processes may occur in parallel. As a non-limiting example, insertion positions 156 for every object model 116 desired to be inserted by be determined (and feasibility checked) before proceeding to RGB or LIDAR ray casting as described further below. In some embodiments, 10 object models 116 may be inserted. In some embodiments, 50 object models 116 may be inserted. In some embodiments, 100 object models 116 may be inserted. In some embodiments, 250 object models 116 may be inserted. In some embodiments, 1-250 object models 116 may be inserted. In some embodiments, 10-250 object models 116 may be inserted. In some embodiments, 100-240 object models 116 may be inserted. In some embodiments, the number of object models 116 to be inserted may be a function of the width of the inserted object model. For a non-limiting example, if object model 116 has a higher width, then fewer object models 116 may be inserted. As another non-limiting example, if object model 116 has a lower width, then more object models 116 may be inserted.

With continued reference to FIG. 1A, memory 112 may include instructions configuring processor 108 to insert object model 116 into 3D space 144. In some embodiments, this may include inserting object model 116 into 3D space 144 to form augmented data 152. Augmented data 152 is real-world data that has been augmented to include one or more object models 116. In some embodiments, insertion process 148 may be repeated multiple times in order to obtain more training datapoints for onboard detection algorithm 184. In some embodiments, processor may be configured to insert object models 116 into 3D space 144 such that they do not occlude one other. The perception system 180 may then be applied to 3D space 144 and visibility/detection status 182 may be computed. If not enough ground truth points with visibility are detected, then this process may return to the 3D space 144 without the insertions and repeat the insertion process. This may allow for denser supervision during training. In some embodiments, detection status 182 may be used as ground-truth detection data for training, e.g., onboard detection algorithm. The ground-truth detection data may be specific to an object category for the inserted object model. For example, if object model 116 is a pedestrian, then the ground-truth detection data generated from inserting object model 116 may be associated with “pedestrian” as a category. This may allow for onboard detection algorithm to be trained on object-type specific data.

With continued reference to FIG. 1A, inserting object model 116 into 3D space 144 may include performing an RGB ray-casting procedure. RGB ray-casting procedure. In some embodiments, this may include updating RGB image pixels (e.g., from real-world camera data 140 with pixels from the inserted object model 116. This may include, in some embodiments, using RGB mask 128 to insert the pixels from object model 116 For example, RGB mask 128 may define the object's silhouette, thereby indicating which pixels from object model 116 should be inserted. This RGB ray casting procedure may help insure realistic visual integration of the object model 116 into 3D space 144. In some embodiments, RGB mask 128 and/or RGB data may be refined to improve the realism of the RGB insertion. As non-limiting examples, this may include receiving seams, adjusting colors, and adjusting for lighting and weather conditions. In some embodiments, this may include using a neural network to refine the RGB data and/or RGB mask 128. In some embodiments, image processing techniques to refine the RGB data and/or RGB mask 128.

With continued reference to FIG. 1A, insertion process 148 may include performing a LIDAR ray-casting procedure. LIDAR ray-casting procedure may include determining a plurality of projected LIDAR points 160, wherein plurality of projected LIDAR points 160 comprise locations where rays from the LIDAR system of autonomous vehicle 132 would intersect object model 116. In some embodiments, determining plurality of projected LIDAR points 160 may be a function of LIDAR system parameters and an object location. Object location may include insertion position 156. LIDAR system parameters may include, as non-limiting examples, a LIDAR scan rate, point density, vertical spacing, scan patterns, and the like. In some embodiments, LIDAR system parameters may be based on a real world LIDAR cloud. In some embodiments, plurality of projected LIDAR points 160 may be determined using a geometric algorithm that projects LIDAR beams from the LIDAR system outward according to the LIDAR system's parameters.

With continued reference to FIG. 1A, memory 112 may include instructions configuring processor 108 to determine depth values 164. Depth values 164 are the distance from the LIDAR system to the particular plurality of projected LIDAR points 160 on object model 116. In some embodiments, depth values 164 may be determined using LIDAR mask 124 of object model 116. For example, in some embodiments, LIDAR mask 124 may include depth values relative to an original LIDAR sensor that collected object model 116. Geometric computations may be used to determine depth values 164 which are relative to LIDAR system of autonomous vehicle 132 using insertion position 156.

With continued reference to FIG. 1A, insertion process 148 may include geometrically modeling, as a function of depth values 164 and projected LIDAR points 160, return locations 168 for LIDAR rays that hit projected LIDAR points 160. For example, this may include determining a reflection of a LIDAR ray based on depth values 164. The updating of LIDAR point cloud for 3D space 144 may further include a LIDAR ray-casting procedure that is employed to generate a physically accurate LIDAR point cloud representation of the inserted object. In certain aspects, LIDAR ray-casting procedure may use RGB mask 128 defining the object's silhouette. Particularly, the generated points (e.g., plurality of projected LIDAR points 160) maybe designed to closely resemble those that would be captured by a real LIDAR sensor. In some embodiments, a height value 172 of the inserted object may be determined using a road level 176. For the purposes of this disclosure, the “height value of the inserted object” is the height at which the object will be inserted; particularly, the position of the center of the object along its vertical axis. Road level 176 may be inherited from 3D space 144. In some embodiments, road level 176 may be determined by one or more sensing system on autonomous vehicle 132. In some embodiments, object model 116 may be located at road level. In some embodiments, object model 116 may be located above road level (e.g., where object model 116 is an overhead sign). In these cases, the height values 172 for object model 116 may be adjusted using road level 176 to integrate object model 116 into 3D space 144. In some embodiments, insertion process 148 may include modeling occlusion of an object model 116 based on data from the target scene into which object model 116 is being inserted. In some embodiments, this may include generating projected LIDAR points using occlusions that may be present in the target scene.

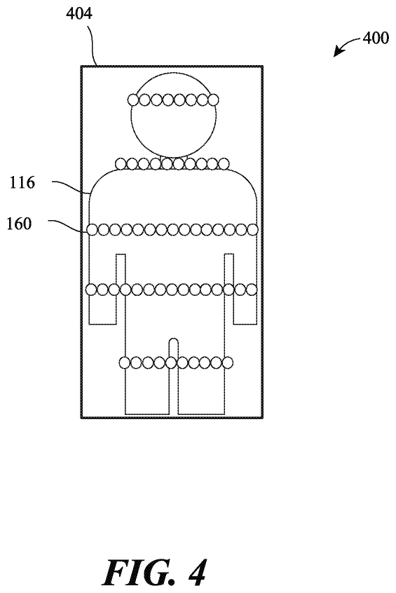

Referring now to FIG. 4, an exemplary embodiment 400 of plurality of projected LIDAR points 160 on an object model 116 is shown. Exemplary embodiment 400 may include a bounding box 404, which may surround object model 116. Plurality of projected LIDAR points 160 may be spaced out in lines as set by LIDAR system parameters. For example, a LIDAR system may be capable of a certain horizontal points spacing (depending on the objects distance from the LIDAR system) and a certain vertical spacing; this may be reflected by plurality of projected LIDAR points 160. Plurality of projected LIDAR points 160 represent the projected locations where the rays from a LIDAR system of autonomous vehicle 132 will meet object model 116. Plurality of projected LIDAR points 160 are not the original lidar points from the original scene (e.g., LIDAR mask 124). In some embodiments, plurality of projected LIDAR points 160 may be determined using a scanning pattern of LIDAR system of autonomous vehicle 132.

With continued reference to FIG. 4, interpolation may be used to interpolate between the LIDAR points in LIDAR mask 124 and plurality of projected LIDAR points 160. For example, this may be needed when the collected LIDAR points in LIDAR mask 124 do not correspond with plurality of projected LIDAR points 160; this may be, as non-limiting examples, due to different scanning patterns between LIDAR systems, different parameters between LIDAR systems, different road levels 176, and different distances between the object model 116 and the LIDAR system. In some embodiments, linear interpolation may be used to interpolate between different LIDAR points. In some embodiments, local plane interpolation may be used to interpolate between different LIDAR points. Local plane interpolation may be used to determine unknown values at plurality of projected LIDAR points 160 by fitting multiple, separate polynomial planes to small, overlapping neighborhoods of data points. In this manner, data for plurality of projected LIDAR points 160 (e.g., depth values 164) may be determined. This is an improvement over other methods because it allows for the realistic insertion of object model 116 into a scene and takes into account the locations at which the LIDAR sensor would measure object model 116 in the scene to improve the insertion.

Referring to FIG. 1A, in some embodiments, memory 112 may include instructions configuring processor 108 to iteratively insert object model 116 into 3D space 144. This may include iteratively inserting object model 116 into 3D space 144 until a number of inserted object models 116 reaches a desired number of object models 116. As a non-limiting example, if a desired number of object models 116 is 5, then processor 108 may iteratively repeat one or more aspects of insertion process 148 until 5 object models 116 have been inserted into 3D space 144.

With continued reference to FIG. 1A, memory 112 may include instructions configuring processor 108 to import, into augmented data 152, at least a label associated with the object from the object model database 120. For example, label may include “stop sign.” This label may be imported from object model database 120 into augmented data 152 as part of insertion process 148. In some embodiments, this may be referred to as label inheritance. Label inheritance may include the labeling of the inserted entity being inherited and including point classification (e.g., object type) and 3D bounding box placement.

With continued reference to FIG. 1A, in some embodiments, memory 112 may include instructions configuring processor 108 to determine, using a perception system 180, a detection status 182. In some embodiments, this may include determining, using perception system 180, detection status 182 for each object model 116 of the plurality of object models 116 that have been inserted into 3D space 144. In some embodiments, perception system 180 may be architecturally coupled with the onboard detection algorithm 184. For example, this may include sharing a backbone or encoder. This may operate to improve real-time performance and accuracy.

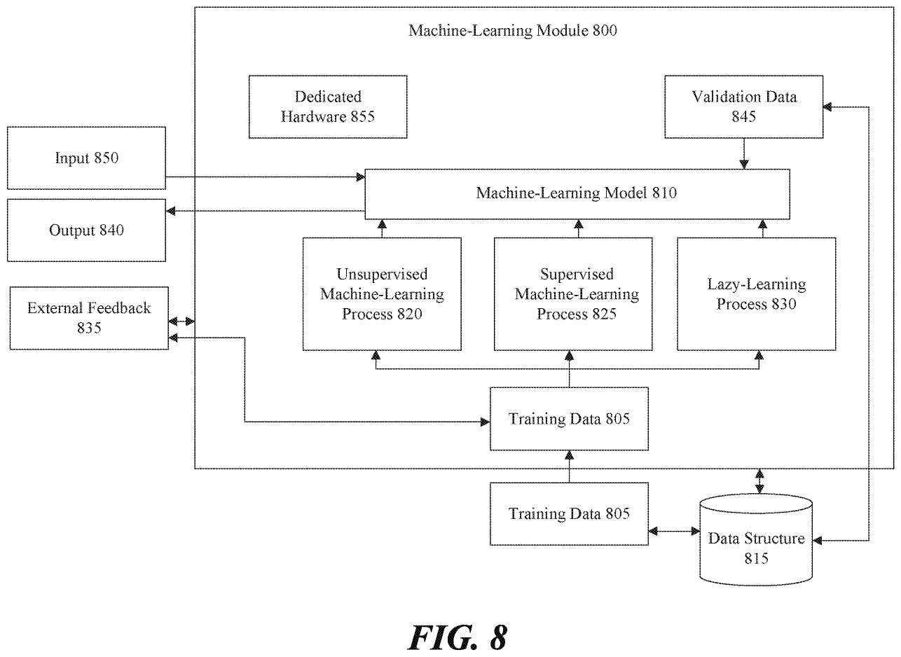

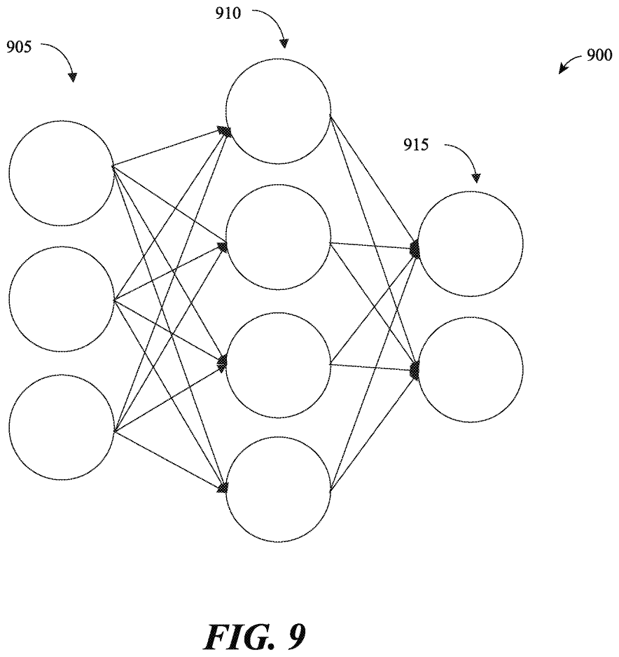

With continued reference to FIG. 1A, perception system 180 may include a neural network as described further with respect to FIGS. 8 and 9. In some embodiments, perception system 180 may include a convolutional neural network. In some embodiments, perception system 180 may include an object detection neural network. In some embodiments, perception system 180 may include a hybrid transformer. In some embodiments, perception system 180 may include a convolution-based neural network architecture. In some embodiments, perception system 180 may include a hybrid transformer and convolution-based neural network. Perception system 180 may be configured to identify objects within 3D space 144, thereby outputting bounding boxes for those objects. In some embodiments, perception system 180 may be trained on labeled data comprising one or more objects to be detected. In some embodiments, labeled data may include LIDAR data and/or camera data. In some embodiments, the teachings of this disclosure may be applied to a method of blind spot detection for any object detector; this may include hand-crafted object detectors and/or machine-learning object detectors.

With continued reference to FIG. 1A, perception system 180 may be used to attempt detection of the one or more inserted object models 116. In some embodiments, a cell of an visibility grid may be defined as “visible” if an object of interest is detected by perception system 180. In some embodiments, object of interest may be in the center of the cell. In some embodiments, a cell may be defined as “obscured” if an object of interest is not detected within cell. Non-detection, as non-limiting examples, could arise due to sensor limitations or physical occlusions.

With continued reference to FIG. 1A, memory 112 may include instructions configuring processor 108 to determine a detection status 182 for inserted object models 116 as a function of comparing a detected bounding box to a model bounding box. Determining detection status 182 may include using perception system 180 to see if perception system 180 detects the inserted object model 116. In some embodiments, perception system 180 may be configured to determine a detected bounding box for inserted object models 116. This may be an output of perception system 180. Detected bounding box is a bounding box that is generated by a perception system for an object model that has been inserted into a scene. In some embodiments, memory 112 may include instructions configuring processor 108 to determine a model bounding box for inserted object models 116. In some embodiments, determining a model bounding box for inserted object models 116 may be a function of insertion location. For example, model bounding box may be placed at insertion location. Model bounding box is the bounding box for the model that is inserted into the scene.

With continued reference to FIG. 1A, detected bounding boxes may be compared to model bounding boxes to determine detection status 182. This may include determining a geometric overlap of the areas of corresponding detected bounding boxes and model bounding boxes. In some embodiments, bounding boxes may be three-dimensional (e.g., cubic). Therefore, determining a geometric overlap may include determining a geometric overlap of the volumes of corresponding detected bounding boxes and model bounding boxes.

With continued reference to FIG. 1A, if the overlap between a detected bounding box and a model bounding box exceeds a bounding box overlap threshold, then the corresponding may be deemed to have been detected by perception system 180. If the overlap between a detected bounding box and a model bounding box falls below a bounding box overlap threshold, then the corresponding may be deemed to have been not detected by perception system 180.

With continued reference to FIG. 1A, in some embodiments, if a object has been deemed to be not detected, then cells behind that object may be labeled as “obscured”. In some cases, the presence or absence of detected inserted objects determines the visibility state of corresponding spatial regions, creating a ground truth map of obscured and visible areas. This may be referred to as a “ground-truth visibility map.” In some embodiments, this detection process may be repeated for each grid cell, thereby creating a comprehensive ground truth map of obscured and visible areas.

With continued reference to FIG. 1A, memory 112 may include instructions configuring processor 108 to train an onboard detection algorithm 184 to detect objects using ground truth detection data. Ground truth detection data may include the object detection data and/or the ground-truth visibility map as described above. In some embodiments, perception system 180 may be couples with onboard detection algorithm 184 when onboard detection algorithm 184 is trained. After training, onboard detection algorithm 184 may be frozen. In some embodiments, onboard detection algorithm 184 may include a blind zone detection model coupled with an object detection model in a single neural network.

With continued reference to FIG. 1A, onboard detection algorithm 184 may include a neural network. In some embodiments, onboard detection algorithm 184 may include a detection neural network. In some embodiments, onboard detection algorithm 184 may include a plurality of convolutional layers. Onboard detection algorithm 184 may include one or more transformers. Onboard detection algorithm 184 may include one or more self-attention layers. In some cases, onboard algorithms may include a main perception neural network (e.g., perception system 180) including a special head that determines detection (e.g., onboard detection algorithm 184). Onboard detection algorithm 184 may include 2-4 convolutional layers.

With continued reference to FIG. 1A, this process of generating the ground truth detection data represents an improvement over the prior art. For one, labeled training data can be expensive to obtain or may be hard to find. This process generates ground truth data that can be used for training detection networks, without the need for labeled data. Additionally, this may allow for the training of a less computationally intensive on board detection model, while the more computationally intensive LIDAR and RGB ray tracing is done off board where computational resources are less at a premium.

With continued reference to FIG. 1A, in some embodiments, the estimation of obscured areas using detections status 182 may be as a function of the specific sensor configuration and perception algorithm constraints of the autonomous vehicle. For example, certain sensors and perception systems may degrade differently with distance. The generation of detection status 182 may take that into account by accounting for degraded detection as a function of distance.

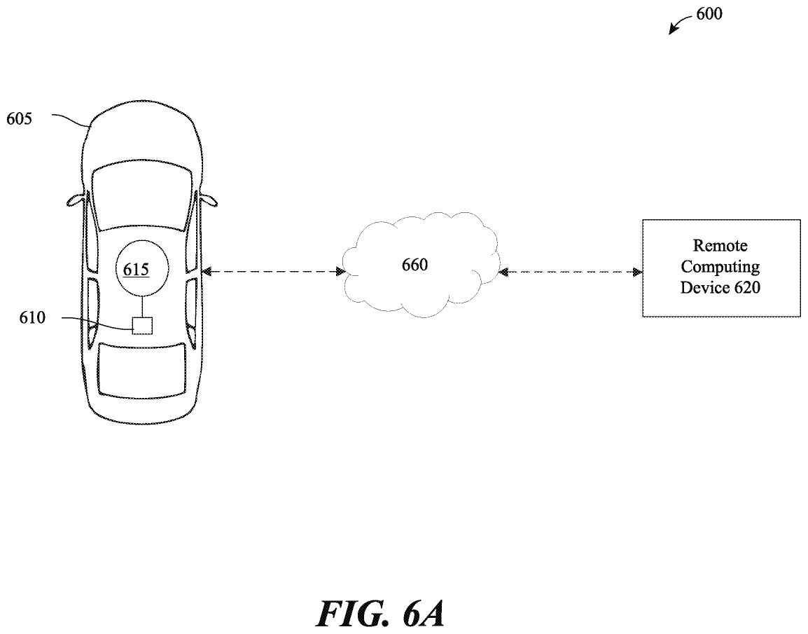

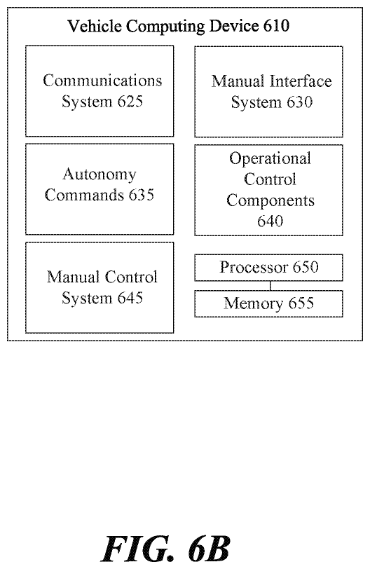

Referring now to FIG. 1B, another exemplary embodiment of a system 100 for automatic estimation of detection system obscured areas for autonomous vehicle navigation is shown. FIG. 1B may show autonomous vehicle 132. In this case, autonomous vehicle 132 may be a vehicle that has been deployed and is not undergoing an algorithm training process as is described in parts with respect to FIG. 1A. Autonomous vehicle 132 may include a data acquisition system 186. Data acquisition system 186 may be consistent with data acquisition system 615 as described further with respect to FIGS. 6A and 6B. Data acquisition system 186 may include, as non-limiting examples, LIDAR, cameras, ultrasound, microphones, radars, or the like.

With continued reference to FIG. 1B, data acquisition system 186 may be communicatively connected to vehicle computing device 188. Vehicle computing device 188 may be consistent with vehicle computing device 610 as described further with respect to FIGS. 6A and 6B. Vehicle computing device 188 may be configured to receive, from data acquisition system 186, real-time LIDAR data 190 and real-time camera data 192. “real-time” data is data that is received and processed without substantial delay.

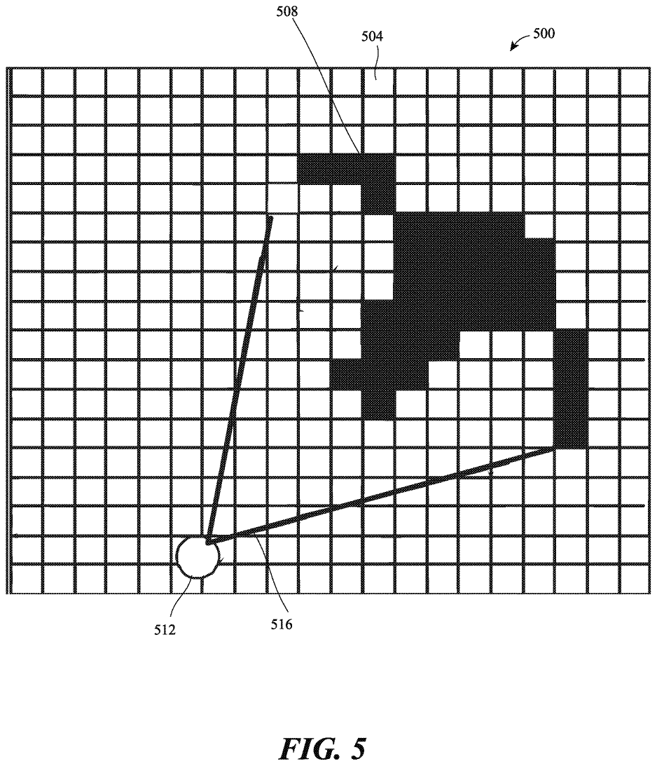

With continued reference to FIG. 1B, in some embodiments, onboard detection algorithm 184 may be configured to receive, as input real-time LIDAR data 190 and real-time camera data 192. In some embodiments, onboard detection algorithm 184 may be configured to output 194 a grid 196. Grid 196 may be consistent with visibility grid 500 described with respect to FIG. 5. In some embodiments, each cell of grid 196 may be associated with a detection status 182. Detection status 182 may be binary. In some embodiments, detection status 182 may include a probability of the cell being obscured (or visible). In some embodiments, onboard detection algorithm 184 may be configured to predict obscured areas in real time based on live sensor inputs. Onboard detection algorithm 184 may include a neural network architecture, optimized for real-time inference on onboard computing platforms, and may be used to process the sensor data and generate the obscured area probability map. The neural network may be trained using the ground truth data generated in the offboard stage. In some embodiments, grid 196 may include class-specific maps. For example, system 100 may be configured to generate different grids 196 (e.g., visibility grid 500) for different object classes. For example, object classes may include pedestrians, vehicles, animals, signs, and the like. As a non-limiting examples, grids 196 pertaining to different object classes may be generated using varying detection thresholds.

### Exemplary Embodiment of a Visibility Grid

Referring now to FIG. 5, an exemplary embodiment of a visibility grid 500 is shown. Visibility grid 500 may include a plurality of cells 504. Cells 504 may represent discretized, non-overlapping segments of visibility grid 500. Plurality of cells 504 may be, as non-limiting examples, rectangular or square. In some embodiments, visibility grid 500 may be extended into three dimensions; for example, cells plurality of cells 504 may be cubes. Cells may be stacked on top of each other to give visibility grid 500 a third dimension.

With continued reference to FIG. 5, in some embodiments, plurality of cells 504 may be empty or otherwise not filled in to signify that a cell has been detected. Plurality of cells 504 may be filled in 508 to signify that a cell has not been detected in some cases, the shading of cells may be reversed so that unfilled cell signify not being detected and filled 508 cells signify being detected.

With continued reference to FIG. 5, in some embodiments, visibility grid 500 may include a vehicle position 512. Vehicle position 512 marks the location of the vehicle on visibility grid 500. In some embodiments vehicle position 512 may not be marked on visibility grid 500. Sensor sight lines 516 are shown on visibility grid 500; however, in some cases, these may not actually be shown on 500. Additionally, it is desired to be noted that visibility grid 500 in FIG. 5 is merely an illustrative embodiment; visibility grid 500 may in some cases be a data structure and thus not be a graphical display as has been rendered here. For example onboard detection algorithm 184 may output a data structure encoding a visibility grid in a manner that is computer readable.

### Exemplary Vehicle Computing Architecture

Referring now to FIGS. 6A and 6B, an exemplary vehicle computing architecture 600 is shown. Vehicle computing architecture 600 may include a vehicle 605. A “vehicle,” for the purposes of this disclosure is a device that is designed to transport goods, people, and/or animals. In some embodiments, vehicle 605 may be motorized. As non-limiting examples, vehicle 605 may include a car, a scooter, an ebike, an ATV, a motorcycle, a motorbike, a minibike, a truck, a golf cart, an aircraft, and the like. In some embodiments, vehicle 605 may be human-powered. As non-limiting examples, vehicle 605 may include a bike, a rickshaw, a skateboard, a scooter, or the like.

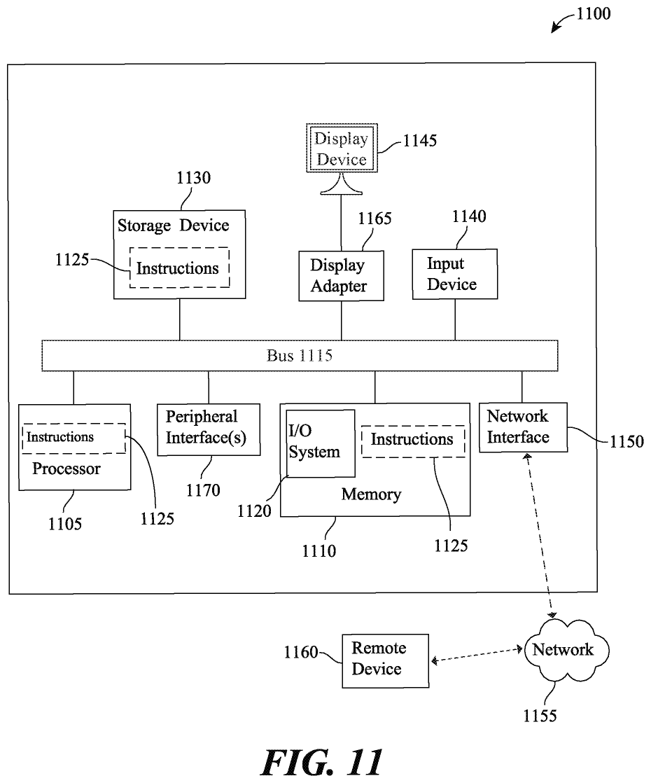

With continued reference to FIGS. 6A AND 6B, the vehicle 605 may be an autonomous vehicle that may drive, navigate, operate, etc. with minimal and/or no interaction from a human driver. Vehicle 605 may include a vehicle computing device 610 that implements a variety of systems on-board the vehicle 605. In some embodiments, vehicle computing device 610 may be consistent with aspects of computing device 1100 described further with respect to FIG. 11.

With continued reference to FIGS. 6A and 6B, in some embodiments, vehicle computing architecture 600 may include one or more data acquisition systems 615. A data acquisition systems 615 may include a plurality of sensors configured to detect data from the environment surrounding or inside of vehicle 605. In some embodiments, data acquisition system 615 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 615 may include one or more LIDAR sensors. In some embodiments, data acquisition system 615 may include one or more ultrasound sensors. For example, ultrasound sensors may be mounted around the perimeter of vehicle 605. In some embodiments, ultrasound sensors may be located on the corners of vehicle 605. In some embodiments, ultrasound sensors may be used for object detection and/or collision avoidance. In some embodiments, data acquisition system 615 may include one or more microphones. In some embodiments, microphones may be arranged in an array. In some embodiments, microphones may include directional microphones. In some embodiments, microphones may include unidirectional microphones. In some embodiments data acquisition system 615 may include one or more RADAR sensors. In some embodiments, data acquisition system 615 may include, as non-limiting examples, lane detectors, optical readers, electric eyes, and/or other suitable types of image capture devices.

With continued reference to FIGS. 6A and 6B, vehicle computing device 610 may include a plurality of vehicle computing devices 610. As a non-limiting example, in some embodiments, vehicle computing device 610 may include, a central computing device and one or more auxiliary computing devices. In some embodiments, auxiliary computing devices may be located on or in the vehicle 605 roof. In some embodiments, auxiliary computing devices may be located close to certain sensors of data acquisition system 615 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 6A and 6B, the vehicle 605 may be configured to enter into a ready state. The ready state may indicate that the vehicle 605 is ready to operate (and/or return to) an autonomous navigation mode. A computing device on-board the vehicle 605 may be configured to determine whether the vehicle 605 is in the ready state. A remote computing device 620 (e.g., associated with an operations control center) may indicate that the vehicle 605 is ready to begin and/or resume autonomous navigation.

With continued reference to FIGS. 6A and 6B, for instance, the vehicle computing system 610 may include a communications system 625, one or more manual interface systems 630, one or more data acquisition systems 615, an autonomy command 635, one or more operational control components 640, and/or a manual control system 645.

With continued reference to FIGS. 6A and 6B, the manual interface systems 630 may be configured to allow interaction between a user (e.g., human) and the vehicle 605 (e.g., the vehicle computing system 610). The manual interface systems 630 may include a variety of interfaces for the user to input and/or receive information from the vehicle computing system 610. The manual interface systems 630 may include one or more input device(s) (e.g., touchscreens, keypad, touchpad, knobs, buttons, sliders, switches, mouse, gyroscope, microphone, other hardware interfaces) configured to receive user input. The manual interface systems 630 may include a user interface (e.g., graphical user interface, conversational and/or voice interfaces, chatter robot, gesture interface, other interface types) for receiving user input.

With continued reference to FIGS. 6A and 6B, vehicle computing system 610 may include a processor 650 and a memory 655. Processor 650 and memory 655 may be consistent with other processors and memory described throughout this disclosure. Processor 650 and memory 655 may be communicatively connected. Memory 655 may contain instructions (e.g., software) configured to cause processor 650 to perform one or more actions in accordance with this disclosure.

With continued reference to FIGS. 6A and 6B, vehicle computing architecture 600 may include a remote computing device 620. the remote computing device 620 may include and/or otherwise be associated with one or more computing devices (e.g., computing device 1100, referred to in FIG. 11) that are remote from the vehicle 605. The remote computing device 620 may communicate with the vehicle 605 via one or more communications networks 660. The communications network 660 may include various wired and/or wireless communication mechanisms (e.g., cellular, wireless, satellite, microwave, and radio frequency) and/or any desired network topology. For example, the communications network 660 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 605.

### Exemplary Lidar System

Referring now to FIG. 7, a light detection and ranging (LIDAR) system 700 is a system that uses lasers to measure distances as a function of measuring reflected light. In some embodiments, LIDAR system 700 may include a light amplification by stimulated emission of radiation component (i.e., a laser).

With continued reference to FIG. 7, LIDAR system 700 may include a laser component 705 that may emit an emitted laser beam 710 and LIDAR system 700 may detect when they reflect back to the LIDAR system 700 in the form of returning beams 715 of light. A “laser component,” for the purposes of this disclosure, is a device that emits a laser beam through a process of optical amplification based on the stimulated emission of electromagnetic radiation. A “laser beam,” for the purposes of this disclosure, is a stream of light that is emitted from a laser component. In some embodiments, laser component 705 may be configured to emit infrared light. In some embodiments, laser component 705 may be configured to emit near-infrared light. In some embodiments, laser component 705 may be configured to emit short-wavelength infrared light. In some embodiments, laser component 705 may emit light with a wavelength of 905 nm and 1550 nm.

LIDAR system 700 may include a Light sensor 720. Light sensor 720 may be configured to detect returning beams of light. Light sensor 720 may be configured to both detect light and the time at which light is detected. In some embodiments, Light sensor 720 may include a photodiode. A photodiode is a semiconductor diode sensitive to photon radiation, such as visible light, infrared or ultraviolet radiation, X-rays and gamma rays. Photodiode may produce an electrical current when it absorbs photons. Photodiode may include a PIN structure or p-n junction. As a non-limiting example, when a photon of sufficient energy strikes the diode, it creates an electron-hole pair. This mechanism is also known as the inner photoelectric effect. If the absorption occurs in the junction's depletion region, or one diffusion length away from it, these carriers may be swept from the junction by the built-in electric field of the depletion region. Thus, in examples, holes move toward the anode, and electrons toward the cathode, and a photocurrent is produced. The total current through the photodiode may be the sum of the dark current (current that is passed in the absence of light) and the photocurrent. Dark current may be minimized to maximize the sensitivity of the device.

With continued reference to FIG. 7, in some embodiments, computing device 104 may be communicatively connected to Light sensor 720 and configured to receive light detection data from Light sensor 720. Light detection data may include, as non-limiting examples, intensity data and/or temporal data. Temporal data may include a time (or times) at which light is detected. In some embodiments, computing device 104 may be configured to determine a distance metric as a function of the light detection data. For example, if an object 725 is farther away from a LIDAR system 700 light emitted from LIDAR system 700 will take longer to reflect back and be detected by Light sensor 720; thus, it can be inferred that the object 725 that reflected the light is further away. Conversely, if an object 725 is closer to a LIDAR system 700 light emitted from LIDAR system 700 will take a shorter amount of time to reflect back and be detected by Light sensor 720; thus, it can be inferred that the object 725 that reflected the light is closer. In some embodiments, laser component may include mechanical-type LIDAR.

With continued reference to FIG. 7, LIDAR system 700 may include an interference filter 730. Interference filter 730 may be configured to filter out interfering signals such that the interfering signals do not reach light sensor 720. For example, interference filter 730 may be configured to filter visible light such that visible light does not reach light sensor 720. Interference filter 730 is configured to allow returning beam 715 to allow returning beam 715 to reach light sensor 720.

With continued reference to FIG. 7, LIDAR system 700 may include one or more mirrors or reflective surfaces. The mirrors or reflective surfaces may be configured to redirect and/or reflect emitted laser beam 710 and/or returning beam 715. As a non-limiting examples, LIDAR system 700 may include a scanning mirror 735. Sanning mirror 735 may be configured to reflect an emitted laser beam 710 from laser component 705 out of LIDAR system 700 and towards, e.g., object 725.

With continued reference to FIG. 7, scanning mirror 735 may be configured to rotate about a vertical axis. As a non-limiting example, this may allow LIDAR system 700 to scan a 360 degree area as scanning mirror 735 is rotated about the vertical axis. In some embodiments, scanning mirror 735 may be configured to rotate about a transverse axis. As a non-limiting example, this may allow lidar system 700 to adjust the scanning area vertically.

With continued reference to FIG. 7, scanning mirror 735 may be operatively connected to an actuator. Actuator may include a component of a machine that is responsible for moving and/or controlling a mechanism or system. Actuator may, in some embodiments, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some embodiments, upon receiving a control signal, actuator responds by converting source power into mechanical motion. In some cases, actuator may be understood as a form of automation or automatic control.

Still referring to FIG. 7, in some embodiments, actuator may include a hydraulic actuator. A hydraulic actuator may consist of a cylinder or fluid motor that uses hydraulic power to facilitate mechanical operation. Output of hydraulic actuator may include mechanical motion, such as without limitation linear, rotatory, or oscillatory motion. In some embodiments, hydraulic actuator may employ a liquid hydraulic fluid. As liquids, in some cases, are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. “Single acting” may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. “Double acting” may be used when pressure is applied substantially on each side of a piston; any difference in resultant force between the two sides of the piston causes the piston to move.

Still referring to FIG. 7, in some embodiments, actuator may include a pneumatic actuator mechanism. In some cases, a pneumatic actuator may enable considerable forces to be produced from relatively small changes in gas pressure. In some cases, a pneumatic actuator may respond more quickly than other types of actuators such as, for example, hydraulic actuators. A pneumatic actuator may use compressible fluid (e.g., air). In some cases, a pneumatic actuator may operate on compressed air. Operation of hydraulic and/or pneumatic actuators may include control of one or more valves, circuits, fluid pumps, and/or fluid manifolds.

Still referring to FIG. 7, in some cases, actuator may include an electric actuator. Electric actuator may include any of electromechanical actuators, linear motors, and the like. In some cases, actuator may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. Electric actuator may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may be directly controlled by a control signal for controlling one or more linear motor parameters. Exemplary linear motor parameters include without limitation position, force, velocity, potential, and current.

Still referring to FIG. 7, in some embodiments, an actuator may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanisms, including for example without limitation gears, rails, pulleys, cables, linkages, and the like.

With continued reference to FIG. 7, in some embodiments, actuator may include a vertical actuator 740. Vertical actuator 740 may be consistent with any of the actuators described above. Vertical actuator 740 may be configured to rotate scanning mirror 735 around a vertical axis. In some embodiments, actuator may include a transverse actuator 745. Transverse actuator 745 may be consistent with any of the actuators described above. Transverse actuator 745 may be configured to rotate scanning mirror 735 around a transverse axis.

With continued reference to FIG. 7, lidar system 700 may include a sensor mirror 750. Sensor mirror 750 may be configured to reflect returning beam 715 to light sensor 720.

### Exemplary Machine-Learning Module

Referring now to FIG. 8, an exemplary embodiment of a machine-learning module 800 is shown. Machine-learning module 800 may be configured to perform one or more machine learning processes as described throughout this disclosure. Machine-learning module 800 may perform determinations, classification, and/or analysis steps, methods, processes, or the like as described in this disclosure using machine learning processes. A “machine learning process,” as used in this disclosure, is a process that automatedly uses training data 805 to generate one or more machine-learning models 810.

With continued reference to FIG. 8, for the purposes of this disclosure, “training data” is data that contains correlations that a machine-learning process may use to model relationships between two or more types of data. For example, training data 805 may include one or more training examples. Multiple data entries in training data 805 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 805 may include input training data correlated to output training data. Input training data may include, as a non-limiting example LIDAR and/or camera data, as described further throughout this disclosure. Output training data may include, as a non-limiting example ground-truth visibility data (e.g., a visibility grid), as described further throughout this disclosure. Elements in training data 805 may be linked to descriptors of categories by tags, tokens, or other data elements; for instance, and without limitation, training data 805 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 8, in some embodiments, training data 805 may be divided into different formats, categories, and/or groups. For example, in some embodiments, training data 805 may be divided into one or more cohorts, categorizations, time periods, data sources, and the like. In some embodiments, training data 805 may be assigned to categories using a classifier; as a non-limiting example, a training data classifier. Training data classifier may include a machine-learning module as described elsewhere with respect to FIG. 8. For example, in some embodiments, training data 805 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 800 may generate a classifier using a classification algorithm, defined as a processes whereby a computing device and/or any module and/or component operating thereon derives a classifier from training data 805. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some embodiments, training data 805 may be classified into one or more categories such as sensor types, software versions, vehicle types, localities, and the like.

With continued reference to FIG. 8, training data 805 may be retrieved, in some embodiments, from a data structure 815. A data structure 815 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 815 may be implemented, without limitation, as a relational database, a key-value retrieval database such as a NOSQL database, or any other format or structure for use as a database that a person skilled in the art would recognize as suitable upon review of the entirety of this disclosure. data structure 815 may alternatively or additionally be implemented using a distributed data storage protocol and/or data structure, such as a distributed hash table or the like. data structure 815 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 815 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 805 may be stored in data structure 815. In some embodiments, training data 805 may be retrieved from data structure 815.

With continued reference to FIG. 8, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 8, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 8, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 8, machine-learning process may include an unsupervised machine-learning process 820. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 820 may not require a response variable; unsupervised processes machine-learning process 820 may be used to find interesting patterns and/or inferences between variables, to determine a degree of correlation between two or more variables, or the like.

With continued reference to FIG. 8, machine-learning process may include a supervised machine-learning process 825. Supervised machine-learning process 825 may use training data 805 with both exemplary inputs and expected outputs and use that training data 805 to train a machine-learning model 810. For example, during a training process, machine learning process may evaluate an actual output generated by machine-learning model 810 and compare it to an expected output from training data 805. Based on the difference between the actual and expected outputs, one or more weights within machine-learning model 810 may be updated. For example, in some cases a scoring function may be used to train machine-learning model 810. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 805.

With continued reference to FIG. 8, machine-learning process may include a lazy-learning process 830. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 8, in some embodiments, machine-learning module 800 may receive external feedback 835. External feedback 835 may include, as a non-limiting example, feedback received from a user. In some embodiments, external feedback 835 may be received through a user interface (such as, for example, a graphical user interface (GUI).

With continued reference to FIG. 8, machine-learning module 800 may be configured to re-train machine-learning model 810. In some embodiments, re-training machine-learning model 810 may include re-training machine-learning model 810 as a function of external feedback 835. In some embodiments, external feedback 835 may serve as a source of labeled or partially labeled data that reflects how the model performs in real-world conditions. For example, if a user provides negative external feedback 835, then the set of data from training data 805 may be assigned a negative label. In some embodiments, external feedback 835 may include users correcting an output 840 of machine-learning model 810—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 835, merging it with existing datasets such as training data 805, and/or periodically running a new training cycle to update model parameters.

With continued reference to FIG. 8, machine-learning module 800 may be configured to validate machine-learning model 810. In some embodiments, machine-learning module 800 may validate machine-learning model 810 using validation data 845. Validation data 845 may be a subset of data used to train machine-learning model 805. For example, validation data 845 may include a subset of training data 805. In some embodiments, validation data 845 may include a percentage of training data 805. As non-limiting example, validation data 845 may include 1%,2%, 5%, 10%, 20%, 30%, and the like of training data 805. In some embodiments, machine-learning model 810 may not be exposed to validation data 845 during training. Validation data 845 may acts as a checkpoint that helps determine whether the model is generalizing well or simply memorizing training data 805. As the model learns, its performance on the validation set may be monitored to guide decisions such as choosing hyperparameters, selecting architectures, adjusting regularization strength, or determining when to stop training to avoid overfitting.

With continued reference to FIG. 8, machine-learning model 810 may be configured to receive one or more inputs 850 and generate, as a function of the one or more inputs 850, one or more outputs 840. Outputs 840 may be presented to users for example trough user interfaces and/or GUIs. In some embodiments, external feedback 835 may be received users as a function of output 840.

With continued reference to FIG. 8, one or more, processes, machine-learning processes, actions, steps, or the like as disclosed above may be performed using dedicated hardware 855. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 855 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 855 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 855 to perform one or more operations described herein, such as evaluation of model and/or algorithm outputs, one-time or iterative updates to parameters, coefficients, weights, and/or biases, and/or any other operations such as vector and/or matrix operations as described in this disclosure.

### Exemplary Neural Network

Referring now to FIG. 9, an exemplary embodiment of neural network 900 is illustrated. A neural network 900 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 905, one or more intermediate layers 910, and an output layer of nodes 915. Connections between nodes may be created using a process of “training” the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like. In some embodiments, neural network 900 may include a transformer architecture. In some embodiments, neural network 900 may include a self-attention architecture.

### Method for Automatic Estimation of Detection System Obscured Areas for Autonomous Vehicle Navigation

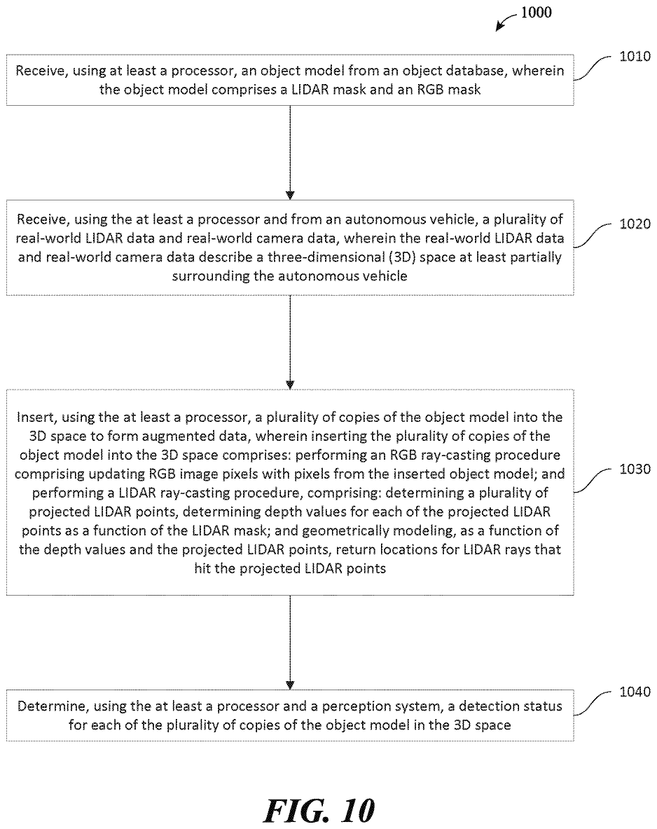

Referring now to FIG. 10, a method 1000 for automatic estimation of detection system obscured areas for autonomous vehicle navigation is shown. Method 1000 includes a step 1010 of receiving, using at least a processor, an object model from an object database, wherein the object model includes a LIDAR mask and an RGB mask. This may be implemented, without limitation, as described with reference to FIGS. 1-9.

With continued reference to FIG. 10, method 1000 includes a step 1020 of receiving, using the at least a processor and from an autonomous vehicle, a plurality of real-world LIDAR data and real-world camera data. In some embodiments, the real-world LIDAR data and real-world camera data describes a three-dimensional (3D) space at least partially surrounding the autonomous vehicle. This may be implemented, without limitation, as described with reference to FIGS. 1-9.

With continued reference to FIG. 10, method 1000 includes a step 1030 of inserting, using the at least a processor, a plurality of copies of the object model into the 3D space to form augmented data, wherein inserting the plurality of copies of the object model into the 3D space includes: performing an RGB ray-casting procedure including updating RGB image pixels with pixels from the inserted object model; and performing a LIDAR ray-casting procedure, including: determining a plurality of projected LIDAR points; determining depth values for each of the projected LIDAR points as a function of the LIDAR mask; and geometrically modeling, as a function of the depth values and the projected LIDAR points, return locations for LIDAR rays that hit the projected LIDAR points. This may be implemented, without limitation, as described with reference to FIGS. 1-9.

With continued reference to FIG. 10, method 1000 includes a step 1040 of determining, using the at least a processor and a perception system, a detection status for each of the plurality of copies of the object model in the 3D space. This may be implemented, without limitation, as described with reference to FIGS. 1-9.

In some aspects, the techniques described herein relate to a method, wherein determining, using the perception system, ground-truth detection data for each of the plurality of copies of the object model in the 3D space includes: determining a detected bounding box for an inserted object model; determining a model bounding box as a function of the inserted object model and an insertion location; and determining a detection status for the inserted object model as a function of comparing the detected bounding box to the model bounding box. This may be implemented, without limitation, as described with reference to FIGS. 1-9.

In some aspects, the techniques described herein relate to a method, wherein determining the ground-truth detection data for the inserted object model as a function of comparing the detected bounding box to the model bounding box includes: determining an overlap metric between the detected bounding box and the model bounding box; determining the detection status to be positive as a function of the overlap metric exceeding an overlap threshold. This may be implemented, without limitation, as described with reference to FIGS. 1-9.

In some aspects, the techniques described herein relate to a method, further including training, using the at least a processor, an onboard detection algorithm to detect objects using the ground-truth detection data. This may be implemented, without limitation, as described with reference to FIGS. 1-9.

In some aspects, the techniques described herein relate to a method, wherein the onboard detection algorithm includes a detection neural network. This may be implemented, without limitation, as described with reference to FIGS. 1-9.

In some aspects, the techniques described herein relate to a method, wherein the detection neural network includes a plurality of convolutional layers. In some embodiments, detection neural network may include a transformer architecture. In some embodiments, detection neural network may include a self-attention architecture. This may be implemented, without limitation, as described with reference to FIGS. 1-9.

In some aspects, the techniques described herein relate to a method, wherein the onboard detection algorithm is configured to receive, as input, real-time LIDAR and real-time camera data and output a grid, each cell of the grid is associated with a detection status. This may be implemented, without limitation, as described with reference to FIGS. 1-9.

In some aspects, the techniques described herein relate to a method, wherein the plurality of projected LIDAR points include locations where rays from the LIDAR system of the autonomous vehicle would intersect the object model, as a function of LIDAR system parameters and an object location; This may be implemented, without limitation, as described with reference to FIGS. 1-9.

In some aspects, the techniques described herein relate to a method, wherein the object model is a model of a commonly-encountered object. This may be implemented, without limitation, as described with reference to FIGS. 1-9.

In some aspects, the techniques described herein relate to a method, further including importing, using the at least a processor, into the augmented data, at least a label associated with the object model from the object model database. This may be implemented, without limitation, as described with reference to FIGS. 1-9.

### A Computing Device in the Exemplary Form of a Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1105 and a memory 1110 that communicate with each other, and with other components, via a bus 1115. Bus 1115 may include any of several types of bus structures including, but not limited to, a memory bus, a memory controller, a peripheral bus, a local bus, and any combinations thereof, using any of a variety of bus architectures.

Processor 1105 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1105 may be organized according to Von Neumann and/or Harvard architecture as a non-limiting example. Processor 1105 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1110 may include various components (e.g., machine-readable media) including, but not limited to, a random-access memory component, a read only component, and any combinations thereof. In one example, a basic input/output system 1120 (BIOS), including basic routines that help to transfer information between elements within computer system 1100, such as during start-up, may be stored in memory 1110. Memory 1110 may also include (e.g., stored on one or more machine-readable media) instructions (e.g., software) 1125 embodying any one or more of the aspects and/or methodologies of the present disclosure. In another example, memory 1110 may further include any number of program modules including, but not limited to, an operating system, one or more application programs, other program modules, program data, and any combinations thereof. Memory 1110 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1100 may also include a storage device 1130. Examples of a storage device (e.g., storage device 1130) include, but are not limited to, a hard disk drive, a magnetic disk drive, an optical disc drive in combination with an optical medium, a solid-state memory device, and any combinations thereof. Storage device 1130 may be connected to bus 1115 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1130 (or one or more components thereof) may be removably interfaced with computer system 1100 (e.g., via an external port connector (not shown)). Particularly, storage device 1130 and an associated machine-readable medium may provide nonvolatile and/or volatile storage of machine-readable instructions, data structures, program modules, and/or other data for computer system 1100. In some embodiments, storage device 1130 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 1125) may reside, completely or partially, within machine-readable medium. In another example, software may reside, completely or partially, within processor 1105.

Computer system 1100 may also include an input device 1140. In one example, a user of computer system 1100 may enter commands and/or other information into computer system 1100 via input device 1140. Examples of an input device 1140 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1140 may be interfaced to bus 1115 via any of a variety of interfaces (not shown) including, but not limited to, a serial interface, a parallel interface, a game port, a USB interface, a FIREWIRE interface, a direct interface to bus 1115, and any combinations thereof. Input device 1140 may include a touch screen interface that may be a part of or separate from display 1145, discussed further below. Input device 1140 may be utilized as a user selection device for selecting one or more graphical representations in a graphical interface as described above.

A user may also input commands and/or other information to computer system 1100 via storage device 1130 (e.g., a removable disk drive, a flash drive, etc.) and/or network interface device 1150. A network interface device, such as network interface device 1150, may be utilized for connecting computer system 1100 to one or more of a variety of networks, such as network 1155, and one or more remote devices 1160 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1155, may employ a wired and/or a wireless mode of communication. In general, any network topology may be used. Information (e.g., data, software, etc.) may be communicated to and/or from computer system 1100 via network interface device 1150.

Computer system 1100 may further include a video display adapter 1165 for communicating a displayable image to a display device, such as display 1145. Examples of a display device include, but are not limited to, a liquid crystal display (LCD), a cathode ray tube (CRT), a plasma display, a light emitting diode (LED) display, and any combinations thereof. Display adapter 1165 and display 1145 may be utilized in combination with processor 1105 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1115 via a peripheral interface 1170. Examples of a peripheral interface include, but are not limited to, a serial port, a USB connection, a FIREWIRE connection, a parallel connection, and any combinations thereof.

Further referring to FIG. 11, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 11, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 11, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1100, processor 1105, and memory 1110 may be virtualized; that is, a virtual machine and/or container may interact directly with such computing system 1100, processor 1105, and/or memory 1110, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1105 comprises a plurality of processors and/or processor cores, virtualization may, in some cases, simulate or emulate a single (virtual) processor whose functions are allocated to one or more of the plurality of processors and/or processor cores. In this case, while processor 1105 may be said to be virtualized, the processor 1105, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www. qemu. org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular methods and systems used to implement the disclosure may be modified without changing the spirit of the disclosure and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for automatic estimation of detection system obscured areas for autonomous vehicle navigation, the system comprising:
at least one processor; and
a memory, wherein the memory contains instructions configuring the at least one processor to:
receive an object model from an object database, wherein the object model comprises a LIDAR mask and an RGB mask;
receive from an autonomous vehicle, a plurality of real-world LIDAR data and real-world camera data, wherein the real-world LIDAR data and real-world camera data describe a three-dimensional (3D) space at least partially surrounding the autonomous vehicle;
insert a plurality of copies of the object model into the 3D space to form augmented data, wherein inserting the plurality of copies of the object model into the 3D space comprises:
performing an RGB ray-casting procedure comprising updating RGB image pixels with pixels from the inserted object model; and
performing a LIDAR ray-casting procedure, comprising:
determining a plurality of projected LIDAR points;
determining depth values for each of the projected LIDAR points as a function of the LIDAR mask; and
geometrically modeling, as a function of the depth values and the projected LIDAR points, return locations for LIDAR rays that hit the projected LIDAR points; and
determine, using a perception system, a detection status for each of the plurality of copies of the object model in the 3D space.

2. The system of claim 1, wherein determining, using the perception system, ground-truth detection data for each of the plurality of copies of the object model in the 3D space comprises:
determining a detected bounding box for an inserted object model;
determining a model bounding box as a function of the inserted object model and an insertion location; and
determining a detection status for the inserted object model as a function of comparing the detected bounding box to the model bounding box.

3. The system of claim 2, wherein determining the ground-truth detection data for the inserted object model as a function of comparing the detected bounding box to the model bounding box comprises:
determining an overlap metric between the detected bounding box and the model bounding box;
determining the detection status to be positive as a function of the overlap metric exceeding an overlap threshold.

4. The system of claim 3, wherein the ground-truth detection data is specific to an object category for the inserted object model.

5. The system of claim 3, wherein the memory contains instructions further configuring the at least a processor to train an onboard detection algorithm to detect objects using the ground-truth detection data.

6. The system of claim 5, wherein the onboard detection algorithm comprises a detection neural network.

7. The system of claim 6, wherein the detection neural network comprises a plurality of convolutional layers.

8. The system of claim 6, wherein the detection neural network comprises a transformer architecture.

9. The system of claim 5, wherein the onboard detection algorithm is configured to receive, as input, real-time LIDAR and real-time camera data and output a grid, each cell of the grid is associated with a detection status.

10. The system of claim 1, wherein the plurality of projected LIDAR points comprise locations where rays from the LIDAR system of the autonomous vehicle would intersect the object model, as a function of LIDAR system parameters and an object location.

11. The system of claim 1, wherein the object model is a model of a commonly-encountered object.

12. The system of claim 1, wherein the memory contains instructions further configuring the at least a processor to import, into the augmented data, at least a label associated with the object model from the object model database.

13. A method for automatic estimation of detection system obscured areas for autonomous vehicle navigation, the method comprising:
receiving, using at least a processor, an object model from an object database, wherein the object model comprises a LIDAR mask and an RGB mask;
receiving, using the at least a processor and from an autonomous vehicle, a plurality of real-world LIDAR data and real-world camera data, wherein the real-world LIDAR data and real-world camera data describe a three-dimensional (3D) space at least partially surrounding the autonomous vehicle;
inserting, using the at least a processor, a plurality of copies of the object model into the 3D space to form augmented data, wherein inserting the plurality of copies of the object model into the 3D space comprises:
performing an RGB ray-casting procedure comprising updating RGB image pixels with pixels from the inserted object model; and
performing a LIDAR ray-casting procedure, comprising:
determining a plurality of projected LIDAR points;
determining depth values for each of the projected LIDAR points as a function of the LIDAR mask; and
geometrically modeling, as a function of the depth values and the projected LIDAR points, return locations for LIDAR rays that hit the projected LIDAR points; and
determining, using the at least a processor and a perception system, a detection status for each of the plurality of copies of the object model in the 3D space.

14. The method of claim 13, wherein determining, using the perception system, ground-truth detection data for each of the plurality of copies of the object model in the 3D space comprises:
determining a detected bounding box for an inserted object model;
determining a model bounding box as a function of the inserted object model and an insertion location; and
determining a detection status for the inserted object model as a function of comparing the detected bounding box to the model bounding box.

15. The method of claim 14, wherein the ground-truth detection data is specific to an object category for the inserted object model.

16. The method of claim 14, wherein determining the ground-truth detection data for the inserted object model as a function of comparing the detected bounding box to the model bounding box comprises:
determining an overlap metric between the detected bounding box and the model bounding box;
determining the detection status to be positive as a function of the overlap metric exceeding an overlap threshold.

17. The method of claim 14, further comprising training, using the at least a processor, an onboard detection algorithm to detect objects using the ground-truth detection data.

18. The method of claim 17, wherein the onboard detection algorithm comprises a detection neural network.

19. The method of claim 18, wherein the detection neural network comprises a plurality of convolutional layers.

20. The method of claim 19, wherein the detection neural network comprises a transformer architecture.

21. The method of claim 17, wherein the onboard detection algorithm is configured to receive, as input, real-time LIDAR and real-time camera data and output a grid, each cell of the grid is associated with a detection status.

22. The method of claim 13, wherein the plurality of projected LIDAR points comprise locations where rays from the LIDAR system of the autonomous vehicle would intersect the object model, as a function of LIDAR system parameters and an object location;

23. The method of claim 13, wherein the object model is a model of a commonly-encountered object.

24. The method of claim 13, further comprising importing, using the at least a processor, into the augmented data, at least a label associated with the object model from the object model database.
